(19) United States
(12) Patent Application Publication
(10) Pub. No.: US 2018/0276020 A1
(43) Pub. Date: Sep. 27, 2018

(54) INFORMATION PROCESSING SYSTEM AND VIRTUAL MACHINE

(71) Applicant: FUJI XEROX CO., LTD., Tokyo (JP)

(72) Inventor: Tadashi KIMURA, Kanagawa (JP)

(73) Assignee: FUJI XEROX CO., LTD., Tokyo (JP)

(21) Appl. No.: 15/669,352

(22) Filed: Aug. 4, 2017

(30) Foreign Application Priority Data
Mar. 24, 2017 (JP) 2017-058693

(51) Int. Cl. G06F 9/455

(52) U.S. Cl. CPC G06F 9/45558; G06F 2009/45575

(57) ABSTRACT

An information processing system includes one or more virtual machines, a container scaling apparatus, and a virtual-machine scaling apparatus. The container scaling apparatus performs autoscaling processing of a container that runs on a virtual machine among the one or more virtual machines. The virtual-machine scaling apparatus performs autoscaling processing of the one or more virtual machines and that stops a virtual machine whose protective state with respect to scale-in has been cancelled among the one or more virtual machines when performing scale-in. Each of the one or more virtual machines includes a controller that performs control in such a manner that the virtual machine is set to a protective state with respect to the scale-in performed by the virtual-machine scaling apparatus if one or more containers are running on the virtual machine.

### CROSS-REFERENCE TO RELATED APPLICATIONS

This application is based on and claims priority under 35 USC 119 from Japanese Patent Application No. 2017-058693 filed Mar. 24, 2017.

### BACKGROUND

### (i) Technical Field

The present invention relates to an information processing system and a virtual machine.

### (ii) Related Art

In hypervisor-based virtualization, which is widely used as a computer virtualization Method, each virtual machine is created on an operating system (OS, host OS) of a physical machine, and an independent guest OS environment is run on the individual virtual machine.

On the other hand, in container-based virtualization, which has been widely used. in recent years, resources are made to be separate for each user by individually creating an application execution environment for each user on the host OS. Container-based virtualization is more efficient than hypervisor-based virtualization because each user does not have to individually run the guest OS.

In recent years, a hybrid system obtained by combining a hypervisor-based system with a container-based system has also been proposed, In hybrid systems, containers are created on virtual machines.

In a hybrid system of the related art, autoscaling at a virtual-machine level and autoscaling at a container level are performed independently of each other. That is, in the related art, autoscaling of a group of virtual machines is performed in accordance with conditions such as load conditions of the group of virtual machines, and autoscaling of a group of containers is performed in accordance with conditions such as load conditions of the group of containers.

### SUMMARY

According to an aspect of the invention, there is provided an information processing system including one or more virtual machines, a container scaling apparatus, and a virtual-machine scaling apparatus. The container scaling apparatus performs autoscaling processing of a container that runs on a virtual machine among the one or more virtual machines. The virtual-machine scaling apparatus performs autoscaling processing of the one or more virtual machines and that stops a virtual machine whose protective state with respect to scale-in has been cancelled among the one or more virtual machines when performing scale-in. Each of the one or more virtual machines includes a controller that performs control in such a manner that the virtual machine is set to a protective state with respect to the scale-in performed by the virtual-machine s ling apparatus if one or more containers are runnins on the virtual machine.

### BRIEF DESCRIPTION OF THE DRAWINGS

An exemplary embodiment of the present invention will be described in detail based on the following figures, wherein:

FIG. 1 illustrates an example of a system configuration according to the exemplary embodiment;

FIG. 2 illustrates an example of a process procedure of a protective controller, and

FIG. 3 illustrates an example of a process procedure of a virtual-machine autoscaling management apparatus.

### DETAILED DESCRIPTION

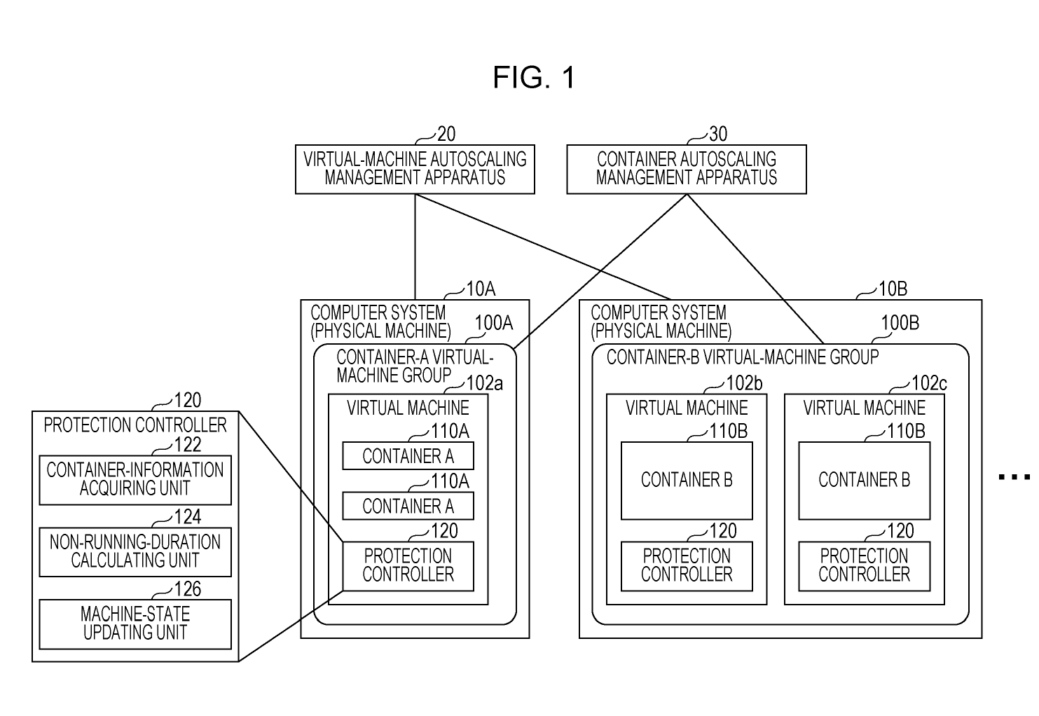

An example of a cloud service system according to an exemplary embodiment will be described with reference to FIG. 1.

The cloud service system in FIG. 1 includes multiple computer systems 10A, 10B, a virtual-machine autoscaling management apparatus 20, and a container autoscaling management apparatus 30.

The computer systems 10A, 10E, . . . (hereinafter collectively referred to as computer systems 10 unless the computer systems have to be distinguished from one another) are systems including one or more physical (i.e., hardware) computers. Each computer includes hardware resources such as one or more central processing units (CPUs), memory devices (primary storage devices), and secondary storage devices. Hvpervisor-based virtualization virtual machines 102a, 102b, 102c, . . . (hereinafter collectively referred to as virtual machines 102 unless the virtual machines have to be distinguished from one another) run on operating systems of the computer systems 10.

Container-based visualization containers 110A, 110E, . . . (hereinafter collectively referred to as containers 110 unless the containers have to be distinguished from one another) run on the individual virtual machines 102, and applications are run in the containers 110. FIG. 1 illustrates two kinds of containers 110: containers A 0A) for a service (application) A and containers B (110E) for a service B. However, needless to say, another kind of container 110 may also be included. As illustrated in FIG. 1, multiple containers 110 of the same kind may run on a single virtual machine 102 (containers A are an example of this case) or may run on multiple virtual machines 102 (containers B are an example of this case). In the example illustrated in FIG. 1, a container-A virtual-machine group 100A, which is a group of virtual machines for hosting the containers A, includes a single virtual machine 102a, and a container-B virtual-machine group 100B, which is a group of virtual machines for hosting the containers B, includes two virtual machines 102b and 102c. Note that although containers 110 of a single kind run on a single virtual machine 102 in the example illustrated in FIG. 1, containers 110 of multiple kinds may run at the same time on a single virtual machine 102. In this case, a virtual machine 102 on which multiple kinds of containers 110 run belongs to a virtual-machine group 10 (the container-A virtual-machine group 100A and the container-B virtual-machine group 100B are collectively referred to as virtual-machine groups 100) corresponding to these multiple kinds of containers. Note that although FIG. 1 illustrates the computer system 10A for hosting the container-A virtual-machine group 100A and the computer system 10B for hosting the container-B virtual-machine group 100B, which are distinguished from each other for ease of understanding, the computer systems 10 do not have to be explicitly distinguished from each other in this manner.

The virtual machines 102 run programs. of protection controllers 120 in addition to the containers 110. The protection controllers 120 will be described later.

The virtual-machine autoscaling management apparatus 20 performs autoscaling at the virtual-machine level, In the autoscaling at the virtual-machine level, scale-out (increasing the number of virtual machines) is performed in accordance with, for example, an increase in the load of the virtual machine group, and scale-in (decreasing the number of virtual machines) is performed in accordance with, for example, a decrease in the load.

Here, a virtual machine 102 may be protected with respect to scale-in. The virtual machine 102 that has been set to a protective state is excluded from a removal target at the time of scale-in during autoscaling. That is, at the time of scale-in, the virtual-machine autoscaling management apparatus 20 stops and removes one or more virtual machines that have been selected on the basis of a certain (predetermined) criterion from among virtual machines that are not in a protective state (i.e., in a non-protective state) with respect to scale-in.

The container autoscaling management apparatus 30 performs autoscaling at the container level. For example, if the load of applications of the containers A increases, the containers A are subjected to scale-out (i.e., a new container A is started), and if the load thereof decreases, the number of containers A is decreased (i.e., a container or containers selected on the. basis of the predetermined criterion from among the existing containers A are stopped and removed).

The virtual-machine autoscaling management apparatus 20 and the container autoscaling management apparatus 30 may be created by running programs on a virtual machine 102 that runs on the cloud service system.

Each protection controller 120 operated on a virtual machine 102 performs control to set and cancel the protective state of the virtual machine 102 with respect to scale-in. In general, in this control, as long as one or more containers 110 are running on the virtual machine 102, the virtual machine 102 is set to a protective state (note that the virtual machine 102 is typically started in order to cause the containers 110 to run thereon, and accordingly, in the actual operation, the virtual machine 102 is set to a protective state upon being started (even if the containers 110 are not started thereon immediately)). In addition, if not a single container 110 is running any longer on the virtual machine 102 in a protective state, the protective state of the virtual machine 102 is cancelled. The virtual machine 102. has a binary flag indicating whether or not the protective state is set. If the protective state is set, the flag is set as ON, for example, and if the protective state is no longer set, the flag is reset as OFF.

Note that the containers 110 may include protection-target containers 110 and non-protection-target containers 110. The protection-target containers 110 are containers that are protected so as not to be forcibly stopped as a result of the stopping of the virtual machine 102. On the other hand, the non-protection-target containers 110 are containershat may be forcibly stopped without a problem as a result of the stopping of the virtual machine 102. For example, when a user registers a template (information that defines various settings of a container 110) of a container 110 that the user wishes to use in the cloud service system, the user specifies whether or not the container 110 is a protection target. As another example, a container 110 that is set so as to run only an application that may be forcibly stopped without a problem may be automatically set as a non-protection target, and other containers 110 may be automatically set as protection targets. In this case, a mechanism (not illustrated) that receives input of the template of the container 110 in the cloud service system may refer to information indicating whether or not an application may be forcibly stopped without a problem in association with the name of the application (this information is stored in the mechanism, for example) to provide the automatic setting.

In an example, such as the above example, in which the protection-target containers 110 and the non-protection-target containers 110 are present, control as to whether or not the protective state of a virtual machine 102 is cancelled is performed in consideration of only the protection-target containers 110 and not in consideration of the non-protection-target containers 110. That is, if not a single protection-target container 110 is running any longer on the virtual machine 102, the protective state of the virtual machine 102 is cancelled even if one or more non-protection-target containers 110 are running thereon. Likewise, it is possible to also perform control to set a virtual machine 102 to a protective state not in consideration of whether or not the non-protection-target containers 110 are running on the virtual machine 102.

In an example, the protection controller 120 includes a container-information acquiring unit 122, a non-running-duration calculating unit 124, and a machine-state updating unit 126.

The container-information acquiring unit 122 acquires information about containers 110 that are running on a virtual machine 102 on which the protection controller 120 is operated (hereinafter, this virtual machine 102 is referred to as a subject machine). The container-information acquiring unit 122 acquiresinformation indicating whether or not one or more containers 110 are running on the subject machine. In an example in which the protection-target containers 110 and the non-protection-target containers 10 are present, the container-information acquiring unit 122 acquires information indicating whether or not the containers 110 running on the subject machine are protection targets.

For example, in the Docker (registered trademark) system, which realizes container-based virtualization, individual containers 110 are each processes performed on an OS, and processes of individual applications are performed in the processes of the containers 110. In this case, by referring to the processes being performed on the OS that is being operated by the subject machine, the container-information acquiring unit 122 may determine the kinds and number of containers 110 running on the virtual machine 102. In addition, if, for example, the protection-target containers 110 and the non-protection-target containers 110 are distinguished one another on the basis of a difference in argument values or the like that are used when the processes f the containers 110 are started, the container-information acquiring unit 122 may determine whether or not the protection-target containers 110 are running (or the number of protection-target containers 110 that are running) on the basis of information about the processes being performed on the subject machine.

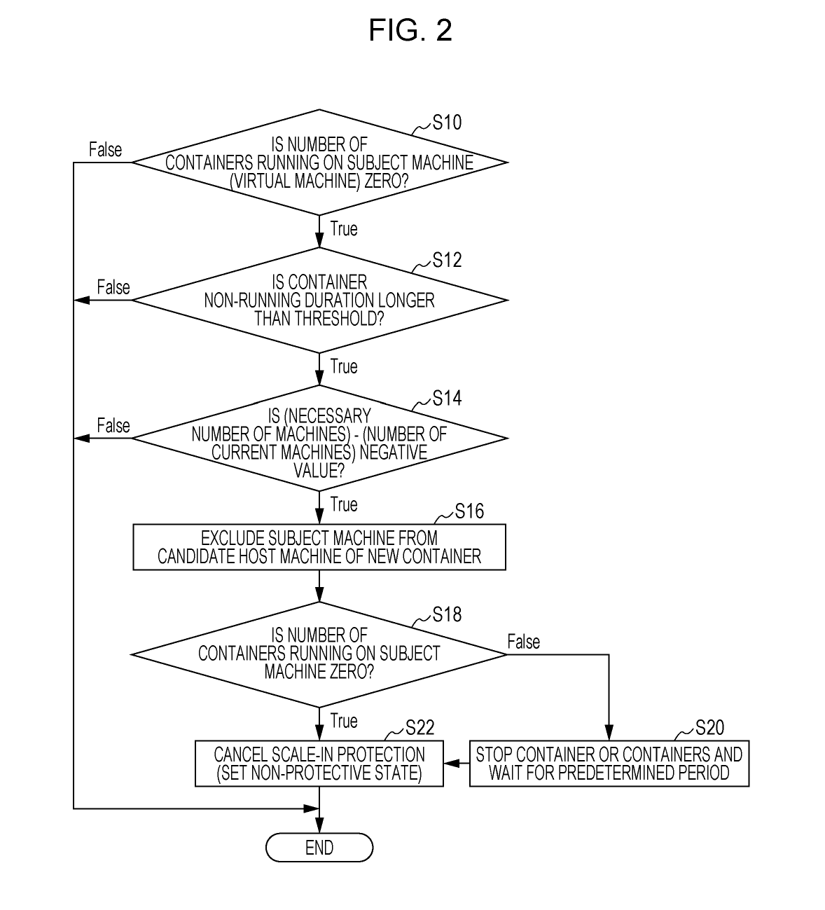

The non-running-duration calculating unit 124 calculates the time that elapses from when not a single container 110 is running any longer on the subject machine (hereinafter, this time is referred to as a non-running duration). In an example, the non-running duration calculated by the non-running-duration calculating unit 124 is used to determine cancellation of the protective state of the subject machine (procedure in FIG. 2 described later).

The machine-state updating unit 126 sets and cancels the protective state of the subject machine with respect to scale-in. The cancellation of the protective state is controlled in accordance with the running status of the containers 110 acquired by the container-information acquiring unit 122. In addition, the machine-state updating unit 126 may update the state as to reflect whether the subject machine is a candidate host machine that hosts a container 110 to be newly started (i.e., a machine that causes the container 110 to run) (this state is hereinafter referred to as candidate-host state). When it is determined that there is a need to start a new container 110, the container autoscaling management apparatus 30 selects a virtual machine 102 on which the new container 110 is to be started from among virtual machines 102 whose candidate-host state is “host possible” (starting of the new container 110 allowed) . The candidate-host state is updated through a procedure in FIG. 2 described later.

An example of a process procedure of the protection controller 120 will be described with reference to FIG. 2. This procedure corresponds to a process in which the protection controller 120 in a virtual machine 102 that is set to a protective state cancels the protective state. This process is performed on a regular basis, for example, Prior to this process, for example, the virtual machine 102 is set to a protective state automatically when the virtual machine 102 is started, or the virtual machine 102 is set to a protective state after the virtual machine 102 has been started in accordance with a user instruction or the like.

First, the protection controller 120 determines whether or not the number of containers 110 that are running on the subject machine (the virtual machine 102) is zero on the basis of information acquired by the container-information acquiring unit 122 (S10). In an example, “running” a container 110 on the subject machine means that a process of the container 110 is being performed on an OS of the subject machine (another example will be described later). In this example, if one or more processes of the containers 110 are being performed on the OS of the subject machine, the result of the determination “IS NUMBER OF CONTAINERS RUNNING ON SUBJECT MACHINE ZERO?” in S10 is NO (false). In this case, the protection controller 120 ends the process, and thereby the protective state of the subject machine retained. Since at least one container 110 is running on the subject machine, the protective state is retained.

If the result of the determination in S10 is YES (true) (i.e., if no containers 110 are running on the subject machine), the protection controller 120 causes the non-running-duration calculating unit 124 to calculate the non-running duration of the containers 110 on the subject machine. Then, it is determined whether or not the non-running duration is longer than a predetermined threshold (S12). For example, at the time point when it is found that no containers 110 are running on the subject machine on the basis of information acquired by the container-information acquiring unit 122 on a regular basis, for example, the non-running-duration calculating unit 124 stores this time point as a non-running starting time, The non-running-duration calculating unit 124 obtains the time that elapses from the stored non-running starting time to the current time as the non-running duration. Note that the non-running starting time is stored and is then cleared (deleted) if it is found, on the basis of the information acquired by the container-information acquiring unit 122 on a regular basis, for example, that one or more containers 110 are running on the subject machine. If the non-running starting time is not stored, the non-running-duration calculating unit 124 does not calculate the non-runninr duration.

If it is determined in S12 that the non-running duration is not longer than the threshold (false), the protection controller 120 retains the protective state of the subject machine and ends the process. The determination of the non-running duration in S12 is performed so as to prevent the protective state from being cancelled easily. For example, if the protective state is cancelled immediately when it is determined that none of the containers 110 are running on the subject machine, the subject machine (the v it tual machine 102) may be determined to be a scale-in target and immediately stopped in some cases. In this case, if another new container 110 is started immediately after the stopping, the number of virtual machines 102 might be insufficient. In contrast, if the non-running duration lasts for a while (i.e., longer than the threshold), the need for the virtual machine 102 may be determined to be weak, and even if the protective state is cancelled, t is unlikely that the above-described issue of insufficiency will arise.

If the non-running duration is longer than the threshold (true) in S12, the protection controller 120 determines whether or not “(the necessary number of machines)−(the number of current machines)” (i.e., a resultant value of subtracting the number of current machines from the necessary number of machines) is a negative value (S14) Here, the “necessary number of machines” is the number of virtual machines 102 that is determined to be necessary by the virtual-machine autoscaling management apparatus 20. The necessary number of machines is, for example, calculated by th.e virtual-machine autoscaling management apparatus 20 in accordance with the load of the group of the virtual machines 102 as in the related art. As another example, from the necessary number of containers calculated by the container autoscaling management apparatus 30, the virtual-machine autoscaling management apparatus 20 may calculate the number of virtual machines 102 that are necessary to correspond to the necessary number of containers. In addition, the “number of current machines” the number of virtual machines 102 that are running in the cloud service system.

If the result of the determination in S14 is false e., if “(the necessary number of machines)−(the number of current machines)” is greater than or equal to zero), the number of current machines is smaller than or equal to the necessary number of machines, that is, the number of virtual machines 102 that are currently running is smaller than or equal to the number of virtual machines 102 that is determined to be necessary. In this case, if the protective state of the subject machine is cancelled to allow the stopping of the subject machine, the possibility that the number of virtual machines 102 becomes insufficient is high. Therefore, in this case, the protection controller 120 does not cancel the protective state and ends the process.

If the result of the determination in S14 i.s true (i.e., if “(the necessary number of machines)−(the number of current machines)” is less than zero), the number of current machines is greater than the necessary number of machines, that is, the number of virtualmachines 102 that are currently running is greater than the number of virtual machines 102 that is determined to be necessary. In this case, the protection controller 120 proceeds to the process in and after S16. In the process in and after S16, in principle, the protective state of the subject machine with respect to scale-in is cancelled (S22). In the procedure illustrated in FIG. 2, some preparatory steps (S16 to S20) are further performed in order to appropriately cancel the protective state.

That is, the protection controller 120 (the machine-state updating unit 126) cancels the candidate-host state of the subject machine (i.e., the subject machine is excluded from a candidate host machine of a container 110 to be newly started) (S16). Thus, the new container 110 is not started on the subject machine in a period from this step to the completion of cancellation of the protective state of the subject machine.

In addition, the protection controller 120 causes the container-information acquiring unit 122 to acquire the information about the containers 110 that are currently running on the subject machine and, on the basis of this information, determines whether or not the number of containers 110 that are running on the subject machine is zero (S18). It is determined in S10 and S18 whether or not the number of containers 110 that are running is zero because a new container 110 might be started on the subject machine after S10 before S18.

If the result of the determination in S18 is false, since a new container 110 was started on the subject machine after the determination in S10, the protection controller 120 instructs the container 110 or containers 110 to stop and waits for a predetermined period (S20). The predetermined period is a. period that is usually taken from the instruction for stopping the container 110 or containers 110 to the normal stopping of the container 110 or containers 110 (or this period plus a certain amount of time for safety). Upon the predetermined period haying elapsed, the protection controller 120 causes the machine-state updating unit 126 to cancel the protective state of the subject machine (S22).

If the result of the determination in S18 is true, since no containers 110 are currently running on the subject machine, the protection controller 120 (the machine-state updating unit 126) cancels the protective state of the subject machine (S22).

Although the procedure illustrated in FIG. 2 is performed on a regular basis in the above description, this is merely an example. As another example, if the “(the necessary number of machines)−(the number of current machines)” becomes a negative value (i.e., if it becomes necessary to perform scale-in of the virtual machine group), the protection. controller 120 of each virtual machine 102 may perform the procedure illustrated in FIG. 2.

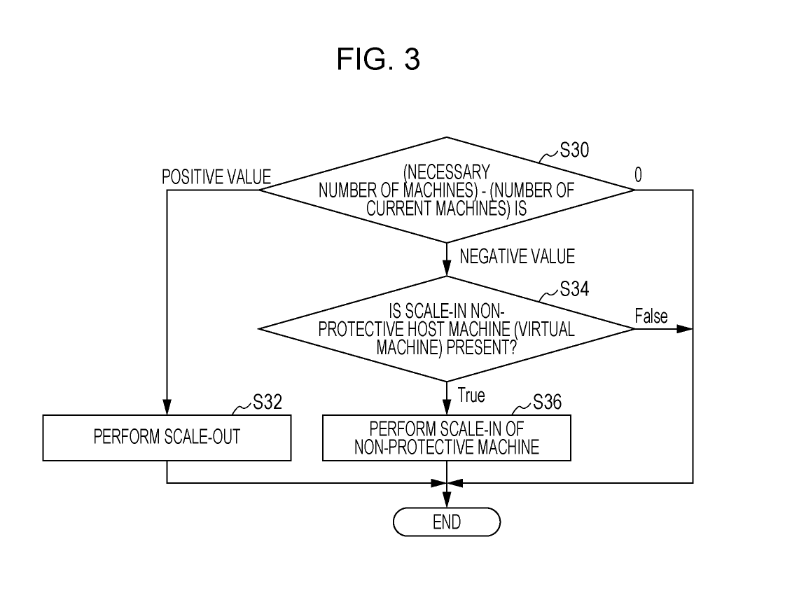

Next, an example of a process procedure of the virtual-machine autoscaling management apparatus 20 will be described with reference to FIG. 3. This procedure is performed on a regular basis, for example.

In this procedure, first, the virtual-machine autoscaling management apparatus 20 determines whether the value of “(the necessary number of machines)−(the number of current machines)” is a positive value, a negative value, or zero (S30). The index “(the necessary number of machines)−(the number of current machines)” has already been described above.

If “(the necessary number of machines)−(the number of current machines)” is a positive value, the number of current virtual machines 102 is smaller than the necessary number of machines, and accordingly, the virtual-machine autoscaling management apparatus 20 performs scale-out of the group of virtual machines 102 (S32). That is, a new virtual machine 102 is started.

If “(the necessary number of machines)−(the number of current machines)” is zero, the number of current machines is equal to the necessary number of machines, and thus, the number of virtual machines 102 does not have to be increased or decreased. In this case, the virtual-machine autoscaling management apparatus 20 ends the process.

If “(the necessary number of machines)−(the number of current machines)” is a negative value, the number of current virtual machines 102 is greater than the necessary number f machines. In this case, scale-in is attempted. Accordingly, the virtual-machine autoscaling management apparatus 20 searches for a virtual machine 102 that is not in a protective state (scale-in non-protective virtual machine 102) from among the virtual machines 102 (S34). In order to do this, the flag of the protective state of each virtual machine 102 is referred to.

If there are no scale-in non-protective virtual machines 102, none of the virtual machines 102 may be stopped, and accordingly, the virtual-machine autoscaling management apparatus 20 ends the process.

If a scale-in non-protective virtual machine 102 is found, the virtual-machine autoscaling management apparatus 20 stops the found scale-in non-protective virtual machine 102 (S36). If multiple scale-in non-protective virtual machines 102 are found, only one of them may be stopped, or all of,them may be stopped as long as the number of current machines is greater than or equal to the necessary number of machines. In addition, if multiple scale-in non-protective virtual machines 102 are found, a virtual machine 102 with a long non-running duration calculated by the non-running-duration calculating unit 124 may be stopped preferentially.

As described above, in the exemplary embodiment, a virtual machine 102 on which a container 110 is running is controlled in such a manner that the scale-in protective state of is prevented from being cancelled, and accordingly, the container 110 that is running is prevented from being forcibly stopped in accordance with the stopping of the virtual machine 102 as a result of scale-in.

Although “running” a container 110 is a state in which the container 110 has been started on a virtual machine 102 (i.e., a process of the container 110 is being performed on the virtual machine 102) in the above description, this is merely an example. Alternatively, for example, the container-information acquiring unit 122 may refrain from determining that a container 110 is “running” simply because the container 110 has been started on the virtual machine 102 and may determine that the container 110 is “running” if the container 110 further runs an application program, The application program here is set so as to be run by the container 110 in the definition information (template) of the container 110.

Note that the application program to be run by the container 110 may be an application program that causes problems if forcibly stopped (e,g., an. application program that leads to forcible stopping of a service that is desirably provided by using the container 110) and an application program that does not cause any problem even if forcibly stopped (e.g., an application program that is irrelevant to the service), The former program is referred to as a first-type program, and the latter program is referred to as a second-type program. The container-information acquiring unit 122 determines that a container 110 running a first-type program is running and that a container 110 running one or more second-type programs but not running a first-type program is not running.

The container-information acquiring unit 122 logs in to each container 110 that runs on the subject machine and determines whether or not a process is being performed in the container 110 or refers to the name or the like of a program of the process that is being performed, thereby determining whether or not the container 110 is running an application program (or running a first-type program).

If the process of an application program performed by the container 110 involves multi steps,. the application program may be forcibly stopped without a problem in some cases once the process has progressed to a specific step. For example, a case will be considered in which the process of an application program run by the container 110 is a process for translating document data that has been input and for storing the translated data in a storage device. In this application program, when translation is completed and an instruction for storing the translated data from a memory device into a storage device is issued (to a direct memory access (DMA) controller, for example), the data is successfully stared in a normal case, and thus, the application program does not cause any problem if stopped without waiting for a response of normal completion with respect to the instruction. Therefore, upon the process progressing to a step of issuing an instruction for storing data in a storage device, the container 110 that is performing the process may be forcibly stopped without a problem.

Thus, the container-information acquiring unit 122 refers to the progress of a process that is being performed by the container 110 on the subject machine, and if the process has progressed to a predetermined specific step, the container-information acquiring unit 122 determines that the container 110 is not running. In order to enable such control, for example, an application program run by the container 110 allows the progress of the process being performed to be saved as data (e.g., written to file) that is accessible from outside the program. The container-information acquiring unit 122 checks the data in order to determine the progress of the program.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
one or more virtual machine;
a container scaling apparatus that performs autoscaling processing of a container that runs on a Virtual machine among the one or more virtual machines; and
a virtual-machine scaling apparatus that performs autoscaling processing of the one or more virtual machines and that stops a virtual machine whose protective state with respect to scale-in has been cancelled among the one or more virtual machines when performing scale-in,
wherein each of the one or more virtual machines includes a controller that performs control in such a manner that the virtual machine is set to a protective state with respect to the scale-in performed by the virtual-machine scaling apparatus if one or more containers are running on the virtual machine.

2. A virtual machine comprising:
a controller that performs control, if one or more containers are running on the virtual machine, such a manner that the virtual machine is set to a protective state with respect to scale-in performed by a virtual-machine scaling apparatus.

3. The virtual machine according to claim 2, wherein, if no containers are running on the virtual machine, the controller cancels the protective state of the virtual machine with respect to the scale-in performed by the virtual-machine scaling apparatus.

4. The virtual machine according to claim 3, wherein the controller does not cancel the protective state until a duration of a state in which no containers are running on the virtual machine becomes equal to a threshold.

5. The virtual machine according to claim 2,
wherein containers capable of running on the virtual machine include a protection-target container and a non-protection-target container, and
wherein the controller performs control to cancel the protective state of the virtual machine regardless of whether or not the non-protective-target container is running on the virtual machine.

6. The virtual machine according to claim 2, wherein, even if no containers are running on the virtual machine, the controller does not cancel the protective state, if a number of virtual machines running including the virtual machine is greater than or equal to a necessary number of virtual machines.

7. The virtual machine according to claim 2, wherein, if no containers are running on the virtual machine, the controller runs, before cancelling the protective state, a process for excluding the virtual machine from a candidate host machine for hosting a container to be newly started.

8. The virtual machine according to claim 2, wherein, even if a container has been started on the virtual machine, the controller determines that the container is not running, if the container is not running a predetermined program.

9. The virtual machine according to claim 2, wherein, even if a container has been started on the virtual machine, the controller determines that the container is not running, once a process performed by the container has progressed to a predetermined step.
